(19) United States
(12) Patent Application Publication
(10) Pub. No.: US 2015/0300962 A1
(43) Pub. Date: Oct. 22, 2015

(54) Assembly For Inspecting Machine Parts Used In The Production Of Semiconductor Components

(71) Applicant: Texas Instruments Incorporated, Dallas, TX (US)

(72) Inventors: Mohd Azri Hashim, Selangor (MY); Mohd Muzamir Kamalluddin, Kedah (MY)

(73) Assignee: Texas Instruments Incorporated, Dallas, TX (US)

(21) Appl. No.: 14/254,774

(22) Filed: Apr. 16, 2014

(51) Int. Cl. G01N 21/95; G01M 13/00

(52) U.S. Cl. CPC G01N 21/95; G01M 13/00; G01N 2201/06113; G01N 2201/101

(57) ABSTRACT

An assembly for inspecting machine parts used in the production of semiconductor devices, such as integrated circuit (IC) dies. The assembly includes a laser scanning apparatus adapted to precisely measure predetermined parameters of the machine parts.

### BACKGROUND

Production machines used in the assembly line of a semiconductor packaging facility may have various attached machine parts. About 80% of these attached machine parts make direct contact with a semiconductor component that is being produced. The quality of such attached machine parts may be critical to the quality of the semiconductor components that the parts engage during production. An example of such a critical machine part (referred to in the art as a “Piece-Part” or “P-Part”) is a window clamp used in a wire bonding process for production of integrated circuit (“IC”) dies.

Defective machine parts may cause high rejection rates in the semiconductor components produced, with associated higher production costs. For critical machine parts used in wire bonding, a “buy off” procedure is generally used to qualify new and returned parts.

Conventional buy off procedures for critical machine parts normally includes measurement and inspection of parts by an inspector using an optical scope or manual xyz scope. This method requires the inspector to place the machine part on a work piece table and to measure it using a scale that is displayed on an associated monitor. This manually performed process is subject to human error. For example, an operator may sometimes make measurement mistakes or he may fail to make one or more important measurements.

### BRIEF DESCRIPTION OF THE DRAWINGS

FIG. 1 is a top plan view of a window clamp.

FIG. 2 is a schematic cross sectional view of a bond wire supported on an insert and engaged by a defective window clamp.

FIG. 3 is a schematic view showing bowing in the bond wire caused by the defective window clamp of FIG. 2.

FIG. 4 is a schematic isometric view of a laser scanning assembly.

FIG. 5 is a design drawing from a part specification for a window clamp.

FIG. 6 is an illustration of a plurality of laser scanner images of portions of an actual window clamp.

FIG. 7 is a detail cross-sectional elevation view of a portion of a window clamp from a design part specification.

FIG. 8 is a detail cross-sectional elevation view, produced by laser scanning, of a portion of an actual window clamp corresponding to the window clamp in the design part specification of FIG. 7.

FIG. 9 is a compound image of a portion of a window clamp produced by laying the design drawing of FIG. 7 over the laser image of FIG. 8.

FIG. 10 is a flow chart of a method of making integrated circuit devices.

### DETAILED DESCRIPTION

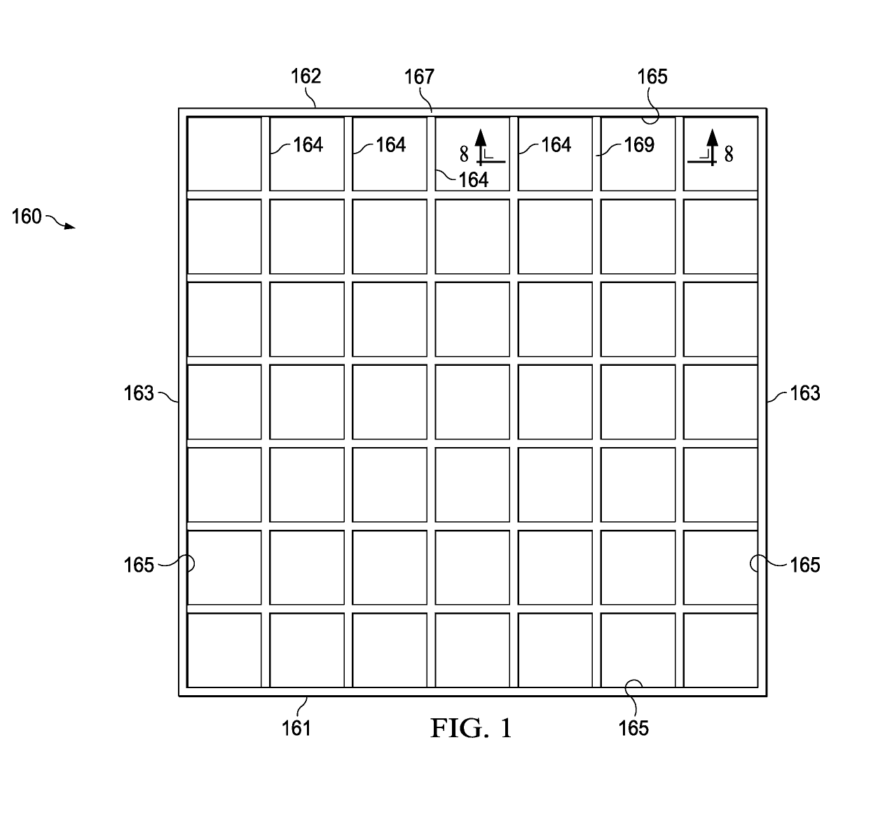

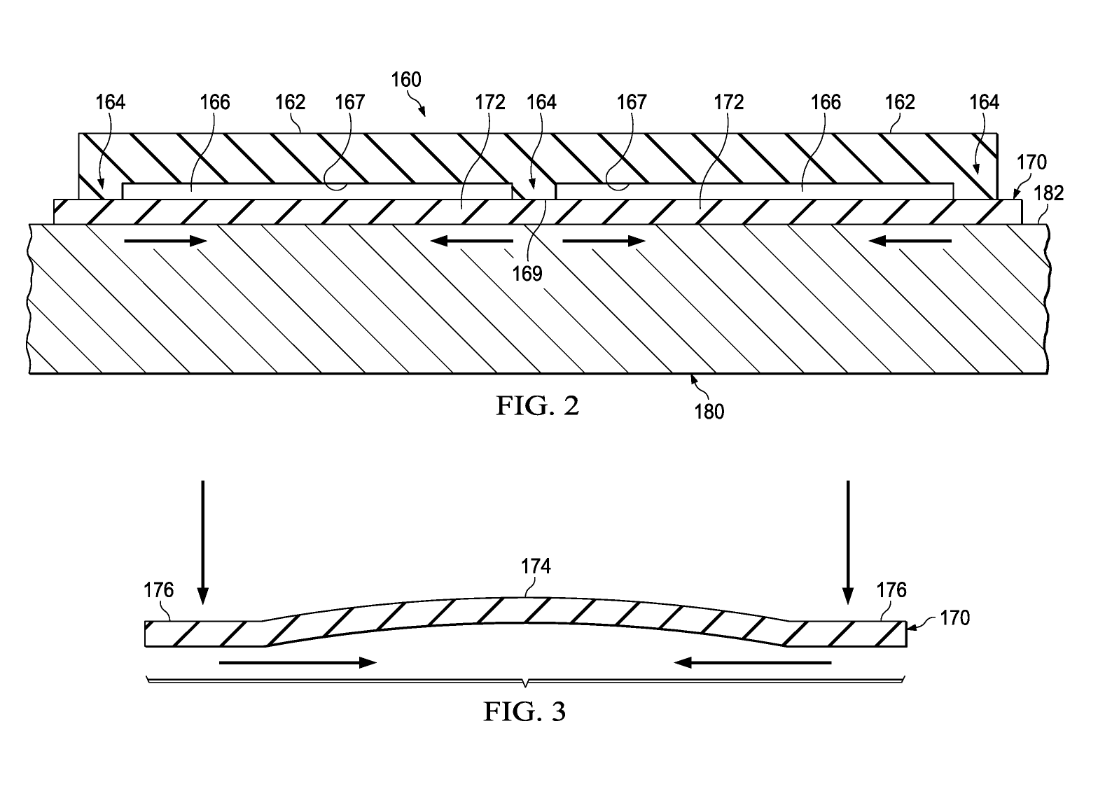

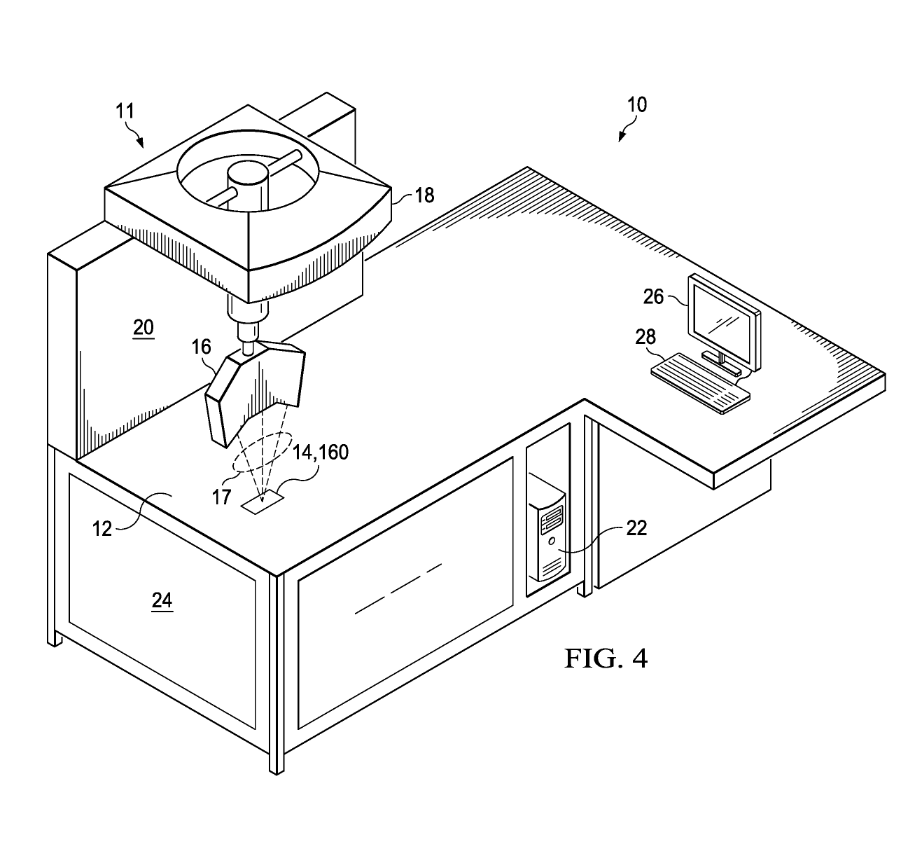

This specification, in general, discloses, as shown by FIG. 4, an assembly 10 for inspecting machine parts 14 used in the production of semiconductor components, such as integrated circuit (IC) devices. The assembly 10 includes a 3D laser scanning apparatus 11 adapted to precisely measure predetermined parameters of a selected machine part, e.g. 160, FIGS. 1 and 2.

FIGS. 1 and 2 illustrate a window frame clamp 160, which is a machine part used in wire bonding operations performed in an integrated circuit die production line. The window frame clamp 160 has a generally rectangular frame formed by a first end frame member 161 a second end frame member 162 and two side frame members 163. A grid work of internal connecting ribs 164 is integrally formed with the frame members 161-163. The ribs 164 are integrally connected to one another and are connected at terminal ends thereof to an inner peripheral surface 165 of the frame members 161, 163. FIG. 2 shows the window frame clamp 160 in a flipped over orientation with respect to the orientation shown in FIG. 1. The clamp 160 is in use to clamp a lead finger 170 to a flat top surface 182 of an insert 180.

The window frame clamp 160 shown in FIGS. 1 and 2 is defective. The top surface 167 of the top frame member 162 should be coplanar with the top surface 169 of the ribs 164, but it is not. Thus, gaps 166 are formed between the top surface 167 of the frame member 162 and the upper surface 172 of the lead finger 170. Because of these gaps 166, constant pressure is not applied by window frame clamp 160 along the length of the lead finger 170. This uneven distribution of clamping pressure causes the portion 174 of the lead finger 170 that was positioned below the gaps 162 to become elevated with respect to the portions 176 that were engaged by the window clamp 160. The defect in lead 170, somewhat exaggerated, which is produced by such uneven pressure distribution and the associated forces applied to the lead finger 170 is shown by FIG. 3. The defect in an IC die product that is produced using such a defective window frame clamp 170 is known as a “floating lead.”

The difference in elevation between surfaces 167 and 169 of the window frame clamp 160, which may cause a floating lead problem, can be as small as 2 to 4 mils. Such small variations in surface elevations of a machine part are extremely difficult to detect using conventional methods. As a result such defective machine parts are often not detected at “buy in,” resulting in the production of defective electronic components. The assembly 10 described below is much more likely to detect such minor differences in dimensions or other machine part parameters than conventional inspection. As a result fewer defective semiconductor devices are likely to be produced.

FIG. 4 illustrates one embodiment of an assembly 10 for inspecting machine parts used in the fabrication of semiconductor devices such as integrated circuit (IC) dies. The assembly 10 includes a three dimensional (“3D”) laser scanning apparatus 11 that is capable of scanning the entire surface area of a machine part 14 and measuring parameters thereof, such as dimensions, angles, surface areas, etc., which may be selected by the operator. The assembly 10 may comprise a scanning head 16, which includes an internal laser for producing a laser scanning beam 17, and a reflected laser beam sensor. The scanning head 16 is mounted on a displacement assembly 18 that allows the laser beam 17 to be swept over a machine part 14 of a machine that is used in the production of semiconductor devices, such as a wire bonder, which is partially shown in FIG. 2.

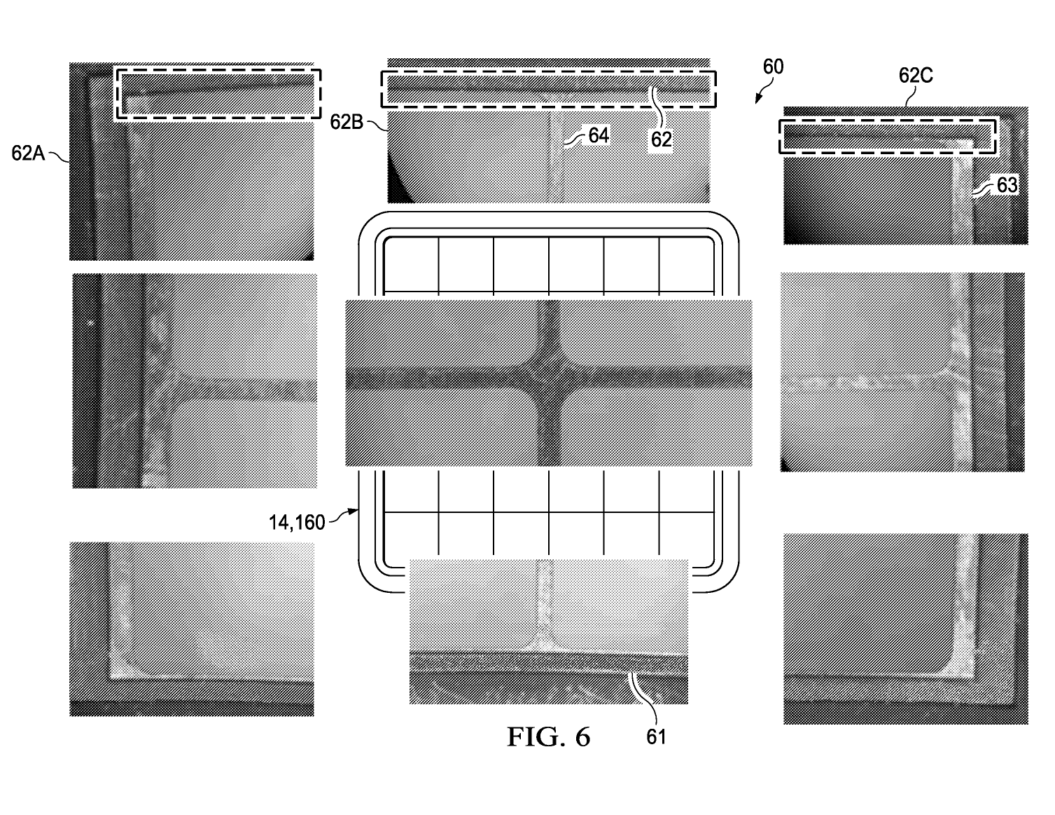

Imaged portions of the machine part 14 may be observed on a scanner monitor 20. Data generated by the scanning head 16 is input to a computer 22 having conventional 3D/CAD scanner software. This data is processed by the computer 22 and is used to generate an image 60, FIG. 6, of the part 14, e.g. clamp 160, on the monitor. Data from the scan is also stored in a memory, which may be located in the computer 22 or elsewhere. An input device, such as a keyboard 28, joystick (not shown), etc., may be used to control scanning and to select regions of the part 14 for which a particular parameter such as area, length, curvature, etc. is desired. The computer 22 may have a separate monitor 26 to facilitate input of instructions, queries, etc. The computer 22 may also have comparison software for comparing numerical values of predetermined measured parameters to numerical values of corresponding design parameters. The assembly 10 may be provided in a desk like housing 24 having a flat table surface 12 for supporting the part 14 that is to be scanned.

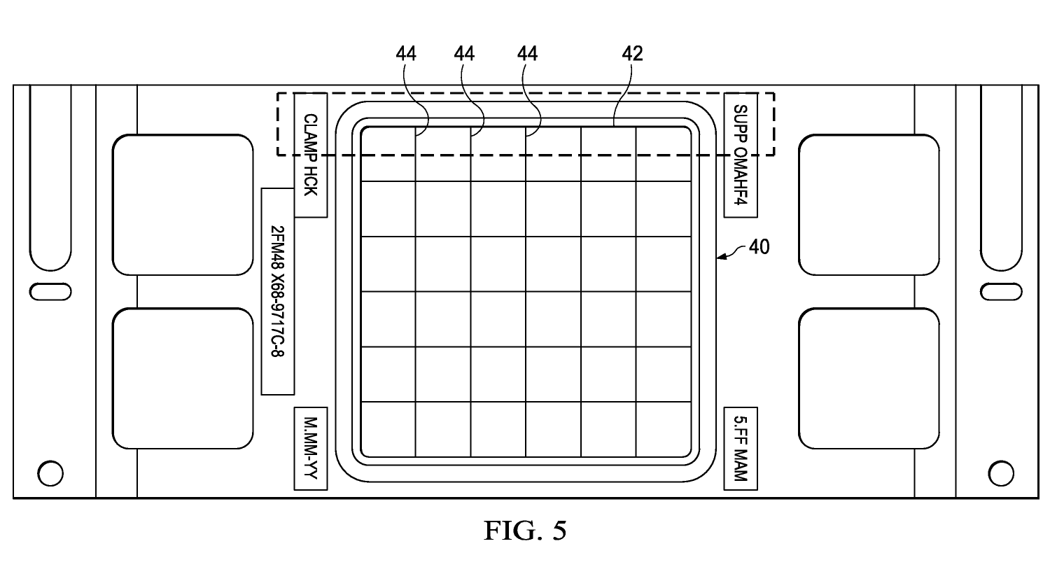

FIG. 5 shows a drawing from a part specification of a design window frame clamp 40 that corresponds to the window frame clamp 160 of FIG. 1. In other words FIG. 5 and multiple other views and data listings (not shown) show all the dimensions and other parameters of an “ideal” or “design” clamp 40. (The numerical dimensions, angles, cross section references, etc. have been omitted from FIG. 5 to avoid clutter. However, it is to be understood that normal design drawings include such information.) Actual clamp 160 is produced using these design clamp 40 parameter value. Thus, if the design clamp parameter were successfully copied, actual clamp 160 would have the same parameters as design clamp 40. However, perfect replication does not always occur and/or the produced part may be damaged during handling, shipment, etc.

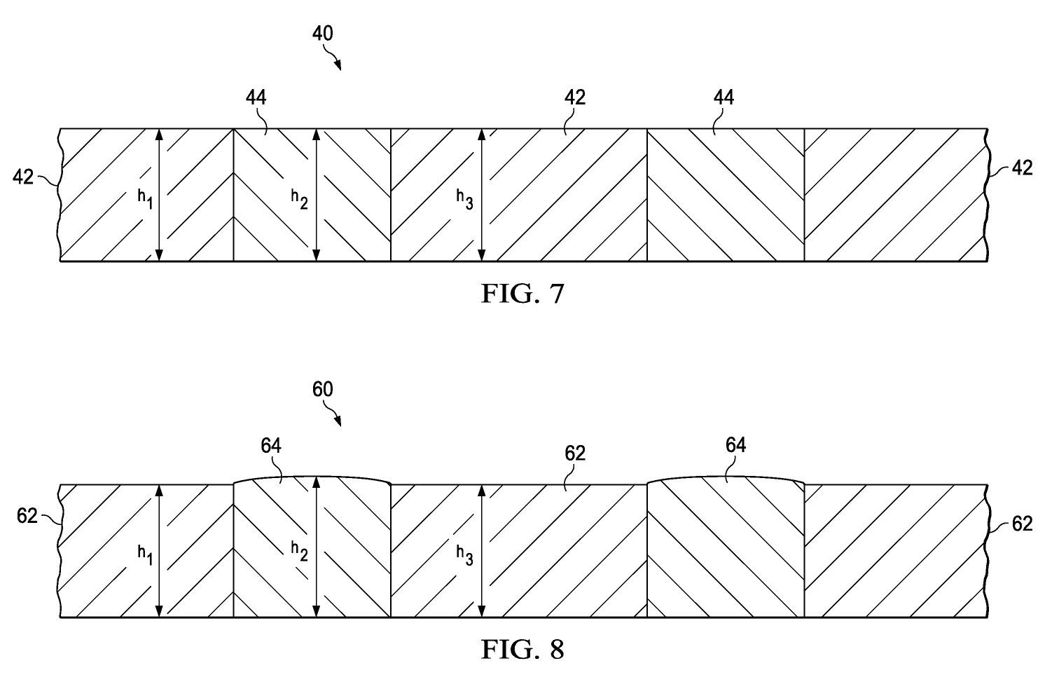

FIG. 6 shows a small number of partial images 60A, 60B, 60C, etc., of the type that would be created by a 3D laser scanner 11 scanning a window clamp 160, such as shown in FIG. 1. These partial images 60A, 60B, 60C, etc., may be assembled into a composite 3D clamp image 60 by conventional stitching software in the computer 22. This 3D image 60 may be rotated and viewed from various perspectives that allow an inspector to choose any particular parameter he wishes to view/measure. Thus, the inspector could select, for example the elevation of each of the surfaces of the image 60 corresponding to the top surfaces 167, 169 of the frame member 162 and adjacent rib member 164, respectively. From this data he could determine if the part 160 is so out of spec as to be likely to produce defective wire bonds and, if it is, reject it. Alternatively, comparison and rejection/acceptance operations could be performed by appropriate software. FIG. 7 shows a detail cross-sectional elevation view of the design window frame clamp 40. FIG. 8 shows a detail cross-sectional elevation view created from the laser image 60 of the actual clamp 160. The inspector/software could compare elevation h₂ of the image in

FIG. 8 to the corresponding design dimension H₂ in FIG. 7 to determine the amount that the height of the rib 164 is at variance with the specification represented by FIG. 8. The inspector could, alternatively, compare various parameters of the image 60 itself, i.e., he could compare h₂ to h₁ and h₃ to determine the size of the rib height defect.

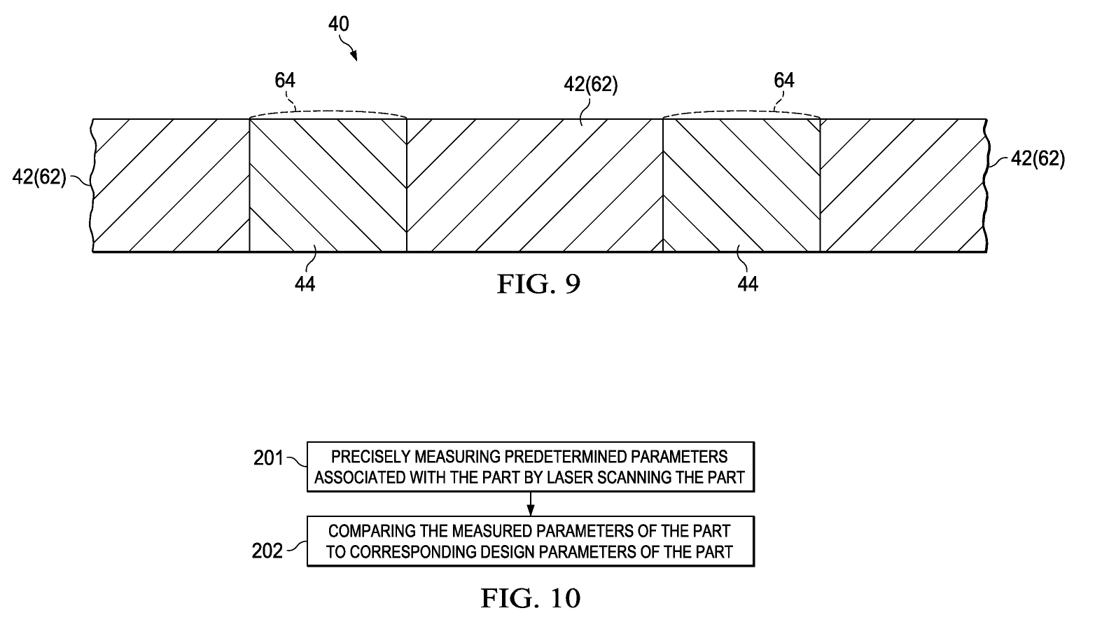

As shown by FIG. 9, the inspector/software could also determine that the heights of the first end rail member 162 and the adjacent rib member 164 were at variance from the specification by superimposing the image 60 of FIG. 8, created by laser scanning, on top the image of FIG. 7, produced using design parameters. From FIG. 9 it can easily be seen that the actual height of imaged member 64 is greater than the height of corresponding portion 44 of the ideal design. Also, the computer software could be configured to determine and display such difference in parameters of the laser image and ideal design parameters to assist the inspector in identifying such incongruities. The inspector could then decide if the differences were sufficient to justify rejecting the machine part 14.

3D scanners, which may be used for the purposes described herein, are commercially available. One such commercially available 3D scanner and associated CAD software is sold by Laser Design Inc., 9401 James Avenue South, Suite 132 Minneapolis, Minn. 55431, having a web site:

www.laserdesign.com.

FIG. 10 illustrates one method of determining whether a machine part designed for use on a semiconductor component production machine is acceptable for use on the machine. The method includes, as shown at 201, precisely measuring predetermined parameters associated with the part by laser scanning the part. The method further includes, as shown at 202, comparing the measured parameters of the part to corresponding design parameters of the part. Comparing the measured parameters of the machine part to corresponding design parameters of the machine part, in one embodiment, comprises comparing numerical values. In another embodiment, it comprises visually comparing a 3D CAD model generated using the measured parameters to a 3D CAD model generated using corresponding design parameters.

Although certain specific embodiments of an assembly for inspecting machine parts have been described herein, it will become obvious to those skilled in the art, after reading this disclosure, that the inventive concepts disclosed herein may be otherwise embodied. It is intended that the claims appended hereto be broadly construed so as to cover such alternative embodiments, except as limited by the prior art.

What is claimed is:

1. An assembly for inspecting machine parts used in the production of semiconductor devices comprising a laser scanning apparatus adapted to precisely measure predetermined parameters of a selected machine part.

2. The assembly of claim 1 further comprising a machine part specification that lists design parameters corresponding to said predetermined parameters of said selected machine part.

3. The assembly of claim 2 further comprising a comparison device adapted to compare said measured parameters to said design parameters of said specification according to predetermined comparison criteria and to provide an output indicative of said comparison.

4. The assembly of claim 3 further comprising a response device adapted to do one of a) rejecting the machine part and b) accepting the machine part in response to said comparison.

5. The assembly of claim 1 further comprising a comparison device adapted to compare said precisely measure predetermined parameters to one another for detecting a defect in said machine part.

6. The assembly of claim 1 further comprising CAD software for generating a 3D model of said machine part using said precisely measure predetermined parameters of said machine part.

7. The assembly of claim 6 further comprising a model comparison device for comparing said generated 3D model of said machine part using said precisely measure predetermined parameters to a 3D design model of said machine part.

8. The assembly of claim 1 wherein said machine part that is inspected is part of said IC production machine that is adapted to engage at least a portion of an IC device during production thereof.

9. The assembly of claim 8 wherein said machine part is a P-Part for a wire bonding process.

10. The assembly of claim 9 wherein said P-part is a window frame clamp having a plurality of frame members and a plurality of ribs.

11. The assembly of claim 10 wherein said plurality of ribs each have a top surface portion and wherein said precisely measured predetermined parameters of said part comprise the height of said top surface portion of each rib at each of a plurality of points thereon.

12. The assembly of claim 10 and wherein deviation of the height of various portions of said top surface of each rib from a rib plane is determined by comparing said precisely measured predetermined parameters to a value determined from a plurality of said precisely measured predetermined parameters.

13. A process for inspecting machine parts of integrated circuit (IC) device production machine comprising precisely measuring a plurality of parameters of a part to be inspected with a laser scanner apparatus.

14. The method of claim 13 further comprising comparing said measured parameters to known design parameters corresponding to said precisely measured parameters.

15. The method of claim 14 wherein said comparing comprises comparing numerical values.

16. The method of claim 13 wherein said comparing comprises optically comparing a 3D model of said machine part constructed using said measured parameters to a 3D model of said machine part constructed using predetermined design parameters corresponding to said measured parameters.

17. The method of claim 16 wherein said optically comparing comprises comparing with human eyes.

18. A method of determining whether a machine part designed for use on an semiconductor component production machine is acceptable for use comprising:
precisely measuring predetermined parameters associated with the machine part by laser scanning the machine part;
comparing the measured parameters of the machine part to corresponding design parameters of the machine part.

19. The method of claim 18 wherein said comparing the measured parameters of the machine part to corresponding design parameters of the machine part comprises comparing numerical values.

20. The method of claim 18 wherein said comparing the measured parameters of the machine part to corresponding design parameters of the machine part comprises visually comparing a 3D CAD model generated using the measured parameters to a 3D CAD model generated using design parameters corresponding to said measured parameters.
